(19) United States
(12) Patent Application Publication
(10) Pub. No.: US 2026/0184266 A1
(43) Pub. Date: Jul. 2, 2026

(54) SEATBACK

(71) Applicants: TS TECH CO., LTD., Asaka-shi (JP); HONDA MOTOR CO., LTD., Tokyo (JP)

(72) Inventors: Hidetsune NONAKA, Shioya-gun (JP); Sachio KOBAYASHI, Shioya-gun (JP); Manabu MATSUMOTO, Wako-shi (JP); Hinako YOKOYAMA, Wako-shi (JP)

(21) Appl. No.: 19/430,632

(22) Filed: Dec. 23, 2025

(30) Foreign Application Priority Data
Dec. 26, 2024 (JP) 2024-231159

(51) Int. Cl. B60R 11/02; B60N 2/68; B60R 16/02; B60R 11/00

(52) U.S. Cl. CPC B60R 11/02; B60N 2/68; B60R 16/0215; B60R 2011/0015; B60R 2011/0043

(57) ABSTRACT

A seatback includes, a seatback frame including a pair of side frames and an upper part frame that extends in a left-right direction and that is joined at both ends to an upper part of the pair of side frames; a harness that supplies power and a signal to an electrical component mounted on the seatback frame; and a harness fixer that fixes the harness to the upper part frame. The harness fixer is located to the front than a rear end of the upper part frame in a front-rear direction of a seat.

### CROSS-REFERENCE TO RELATED APPLICATION

This application is based upon and claims the benefit of priority from the prior Japanese Patent Application No. 2024-231159, filed on December 26, 2024, the entire contents of which are incorporated herein by reference.

### BACKGROUND OF THE INVENTION

### Technical Field

The present disclosure relates to a seatback equipped with an electrical component.

### Description of Related Art

Conventionally, some seatbacks for vehicle seats are equipped with electrical components such as a monitor and a blower. For example, Japanese Unexamined Patent Application Publication No. 2009-125197 describes an invention relating to a mounting structure for attaching a monitor to a back of an upper part of a seatback. International Publication No. 2017/002764 describes an invention relating to a structure for fixing the blower to the seatback frame. Japanese Unexamined Patent Application Publication No. 2012-125754 describes an invention relating to a structure for fixing portable devices to the seatback frame.

In the inventions described in the above-mentioned Japanese Unexamined Patent Application Publication No. 2009-125197 and Japanese Unexamined Patent Application Publication No. 2021-195052, a technique is disclosed for mounting the monitor via the bracket in an upper part of the seatback frame. The invention described in International Publication No. 2017/002764 discloses a technique for mounting the blower via the bracket in the upper part of the seatback frame.

The invention described in Japanese Unexamined Patent Application Publication No. 2012-125754 discloses a technique for attaching portable devices via a fixing member (bracket) to the back of the upper part of the seatback frame. In addition, the Japanese Unexamined Patent Application Publication No.2012-125754 discloses a technique in which a harness fixing section is provided on a mounting surface of a fixing member on a rear face of the portable device.

In the inventions of Japanese Unexamined Patent Application Publication No. 2009-125197, Japanese Unexamined Patent Application Publication No. 2021-195052, and International Publication No. 2017/002764, the structures for attaching electrical components such as monitors and blowers to the seatback frame are disclosed. However, they do not describe how the harnesses that supply power and transmit signals to the monitors and blowers are installed.

In addition, the invention in the Japanese Unexamined Patent Application Publication No. 2012-125754 discloses a technology in which a harness fixing section is provided on the mounting surface of the fixing member. However, the harness fixing section described here is near the portable equipment that receives a supply of power and signals via the harness, i.e., the upper part of the back seat. The fixing section for fixing other parts of the harness is not described.

Therefore, when a load is applied to the seatback or the vehicle vibrates, there is a problem that the harness may shake in the space in the rear of the seatback, resulting in a poor connection.

In addition, since there is only one electrical component in the inventions of Japanese Unexamined Patent Application Publication No. 2009-125197, Japanese Unexamined Patent Application Publication No. 2021-195052, International Publication No. 2017/002764, and Japanese Unexamined Patent Application Publication No. 2012-125754, the number of harnesses being small may not be a problem. However, when multiple electrical components such as the monitor, the blower, and the speaker are installed in the seatback, multiple harnesses will be placed inside or on the rear of the seatback. Therefore, there is the problem that if the harnesses are aimlessly installed, the space in which the harnesses are arranged becomes large, the rear of the seatback becomes cluttered, making it difficult to perform repairs and inspections, and there is a risk that harnesses may rub against each other due to vehicle vibration, causing poor connections.

### SUMMARY OF THE INVENTION

The present disclosure was made in view of the above problem and aims to make a harness arrangement compact at a rear of a seatback equipped with electrical components.

Another object of the present disclosure is to suppress occurrences of poor harness connections in the seatback equipped with electrical components.

To solve the above problem, a seatback reflecting one aspect of the present disclosure includes,

a seatback frame including a pair of side frames and an upper part frame that extends in a left-right direction and that is joined at both ends to an upper part of the pair of side frames;

a harness that supplies power and a signal to an electrical component mounted on the seatback frame; and

a harness fixer that fixes the harness to the upper part frame,

wherein the harness fixer is located to the front than a rear end of the upper part frame in a front-rear direction of a seat.

### BRIEF DESCRIPTION OF DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a front view of an upper frame provided in an upper part of a seatback frame that serves as a frame of a seatback according to an embodiment of the present disclosure;

FIG. 2 is a rear perspective view showing a state of a blower mounted on the upper frame shown in FIG. 1;

FIG. 3A and 3B show an example of a first mounting member that is arranged on a back of the upper frame in a manner that covers a blower unit, FIG. 3A is a front view, and FIG. 3B is a perspective view;

FIG. 4 is a rear view showing a state of the first mounting member including a mounting structure for mounting a monitor and a harness shown in FIG. 3A and FIG. 3B mounted to the upper frame;

FIG. 5A and FIG. 5B show an example of a second mounting member located in a rear part of the first mounting member covering the blower unit, FIG. 5A is a front view and FIG. 5B is a perspective view;

FIG. 6 is a rear view showing a state of the second mounting member shown in FIG. 5A and FIG. 5B attached to the rear part of the first mounting member;

FIG. 7 is a rear view showing an example of a backboard covering the rear part of the seatback;

FIG. 8A is a front view showing a mounted state of a cover case covering the rear part of the mounting structure for the harness, and FIG. 8B is a perspective view showing an example of the cover case; and

FIG. 9 is a rear view of a modification example of a mounting structure for the harness according to the present embodiment.

### DETAILED DESCRIPTION

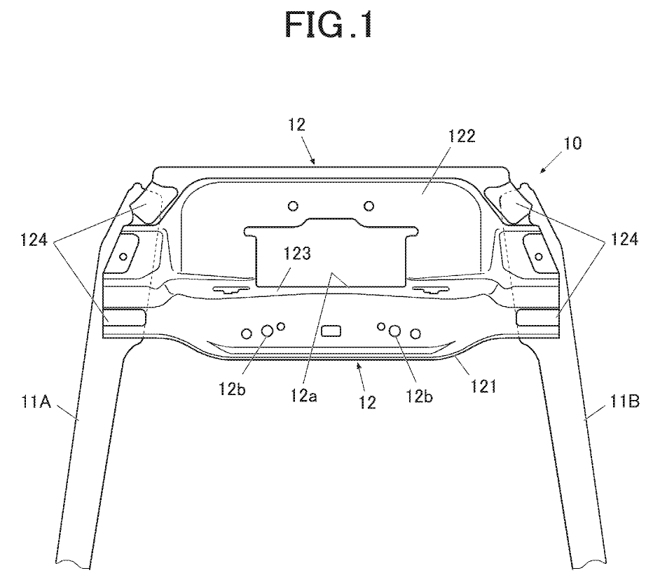

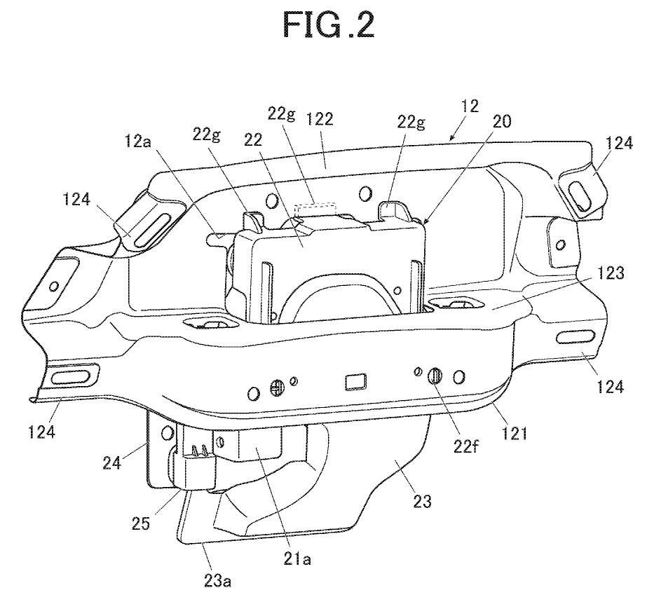

The following is a description of embodiments of a seatback and a vehicle seat according to the present disclosure with reference to the drawings. Regarding the above, FIG. 1 is a front view of the upper frame provided in the upper part of the seatback frame that serves as a frame of a seatback, and FIG. 2 is a rear perspective view showing a state of the upper frame in FIG. 1 attached to the blower. In the following description, unless otherwise mentioned, a travelling direction of a vehicle is referred to as forward (front) and the opposite direction is referred to as backward (rear).

As shown in FIG. 1, the seatback according to the present embodiment includes a seatback frame 10 that includes a pair of left and right side frames 11A and 11B, and a steel upper frame 12 provided in a width direction across upper ends of the side frames 11A and 11B, and that forms a substantial inverted U shape as viewed from a front-rear direction of the seat. The upper frame 12 and the side frames 11A and 11B are welded together to form a rigid joint state.

Although not illustrated, a lower frame is horizontally laid and rigidly joined between the lower ends of the above-described side frames 11A and 11B. On a front face side of the seatback frame 10, a cushion pad made of foam rubber or urethane foam and a pan frame that supports the cushion pad are provided, and a surface of the cushion pad is covered with a cover.

When the seatback according to the present embodiment is used in a vehicle seat, the lower end of the seatback frame 10 is connected to a rear end of the seat cushion frame, which serves as the frame of the seat cushion, in a tiltable manner via a hinge. A headrest is mounted on an upper part of the seatback frame 10.

The side frames 11A and 11B, which form the frame of the seatback, may consist of an inner side frame and an outer side frame, or may be made of a pipe or pan frame.

The upper frame 12 according to the present embodiment includes a base portion 121 of a lower part and a protruding surface portion 122 protruding forward than the base portion 121, and is provided with an opening part 12a for inserting the blower and bracket described below. As shown in FIG. 2, between the base portion 121 and the protruding surface portion 122, there is a horizontal piece portion 123. Such horizontal piece portion 123 is also provided with an opening part, so that the opening part 12a forms an L-shape viewed from the side from the base portion 121 to the protruding surface portion 122. As described above, the protruding surface portion 122 includes a shape protruding forward than the base portion 121, and the opening part 12a is formed from the base portion 121 to the protruding surface portion 122 to form a storage recess portion in which the blower can be stored.

Both sides of the above upper frame 12 are provided with joining surface portions 124 that are joined and adhered to the side frames 11A and 11B.

Furthermore, the base portion 121 of the upper frame 12 is provided with two engagement holes 12b for coupling a bracket 22 to the upper frame 12 by engaging the boss sections 22f (see FIG. 2) provided on the blower mounting bracket 22.

The blower is located on the front face side of the bracket 22. The blower and the bracket 22 are configured to be integrated by engaging a plurality (e.g., three) of engagement holes provided on the rear face of the blower case with a plurality of boss sections provided at corresponding locations on the front face of the bracket 22. The boss sections are formed so that they can be engaged with the engagement holes. The unit is placed and stored in the above storage recess portion as an integrated unit.

Three upwardly protruding ribs or claw-shaped latching pieces 22g are formed on a front edge of an upper wall of the bracket 22. The center one and the two left and right pieces of these three latching pieces 22g are formed so that they are aligned in a substantial straight line with an interval that allows insertion of a flat plate with a thickness of several millimeters, as viewed from above.

In the seatback according to the present embodiment, the blower and the bracket 22 are integrated as described above, and one (upper side) opening of a duct 23 (hereinafter referred to as the blower unit) is connected to the inlet of the blower, which is attached to the upper frame 12. Here, the above three latching pieces 22g provided on the upper part of the bracket 22 are engaged with the upper side edge of the opening part 12a of the upper frame 12.

As a result, the upper part of the bracket 22 for mounting the blower is latched to the protruding surface portion 122 of the upper frame 12, so that the upper side edge of the opening part 12a is sandwiched at the front and rear by the one latching piece 22g in the center and the two latching pieces 22g at the left and the right.

The pair of boss sections 22f on the rear face of the bracket 22 are engaged with the engagement holes 12b provided in the upper frame 12.

This allows the blower unit 20 to be mounted on the upper part of the seatback frame 10 with the blower unit 20 positioned in the opening part 12a of the upper frame 12, as shown in FIG. 2.

The other (lower side) opening of the duct 23 is connected to a correspondingly sized opening that is formed in a lumbar support that supports the rear face of the cushion pad of the seatback, or in a sheet that covers the rear face of the cushion pad (not shown).

According to the present embodiment, the blower is arranged so that the air outlet 21a faces downward and so that the air outlet 21a is in a position biased to the right direction from the center line of the seat, and the duct 23 is arranged in the vertical direction in a position toward the center side of the seat than the air outlet 21a of the blower.

Furthermore, as shown in FIG. 2, according to the present embodiment, the upper end of a strip-shaped mounting plate 24 is adhered to and hangs down from one side (left side in the figure) of the front face of the protruding surface portion 122 of the upper frame 12. Here, the protruding surface portion 122 is located to the front than the base portion 121. Therefore, the mounting plate 24, the upper end of which is adhered to the front face of the protruding surface portion 122, hangs down from the protruding surface portion 122. As a result, the lower part of the mounting plate 24 is farther to the front from the base portion 121 and protrudes lower than the lower edge of the upper frame 12, providing more room in the space.

Therefore, using the above space, a connector 25, which serves as a socket (or plug), is attached to the lower rear face of the mounting plate 24. Specifically, a hole is formed in the lower end of the mounting plate 24 for fastening the connector 25, and the connector 25 is fastened to the mounting plate 24 by inserting a fastening portion (projection) of the connector 25 into this hole. An end of the wire (lead wire) 26 drawn from the blower is connected to this connector 25. The connector 25 is plugged into a connector that serves as a plug (or socket) provided at the end of a power supply harness 27 located in the rear part of the seatback to enable power supply.

As described above, by providing the mounting plate 24 on the upper frame 12 and attaching the connector 25, the harness for power supply can be secured by the connector. This can make contact failures less likely to occur compared to when the harness is in a movable state.

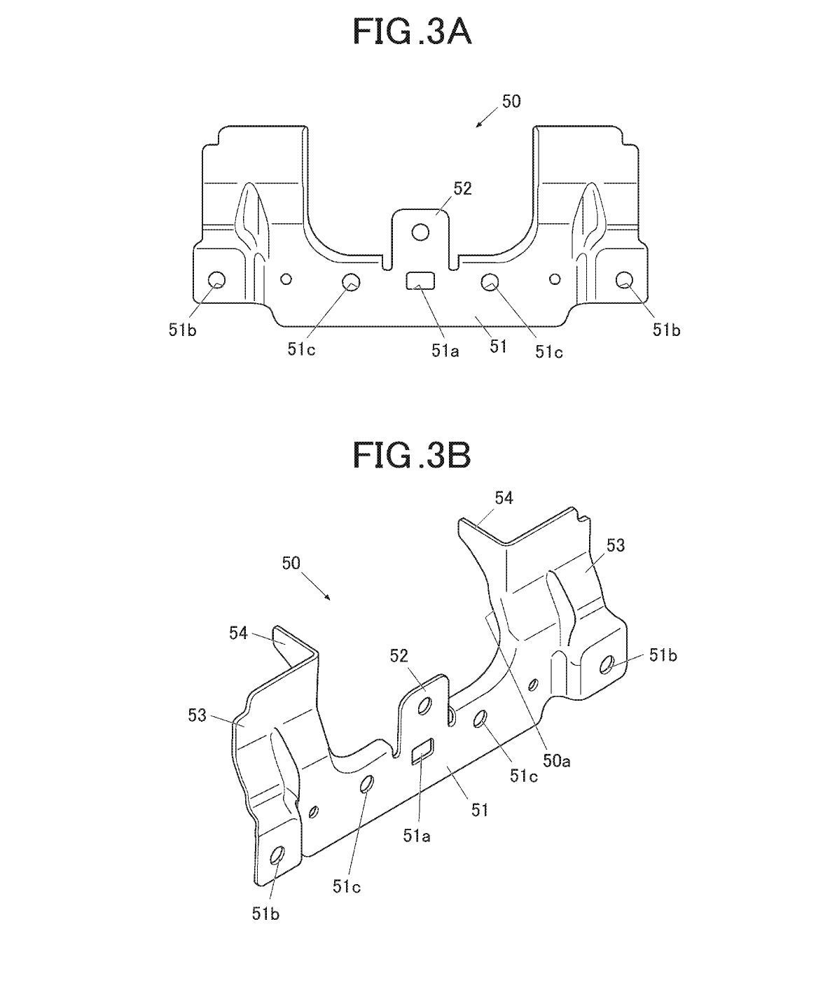

Next, an example of a monitor and harness mounting structure provided in the rear part of the seatback is described with reference to FIG. 3A to FIG. 6.

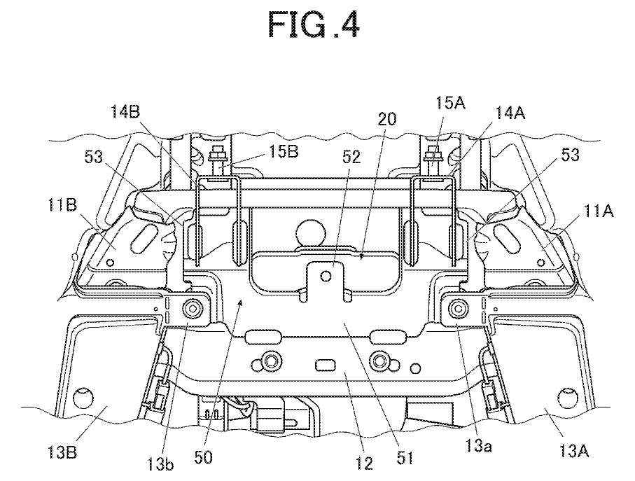

FIG. 3A and FIG. 3B show an example of a first mounting member 50 (first mounter) placed on the rear part of the above-described upper frame 12, and FIG. 4 shows the first mounting member 50 attached to the rear part of the upper frame 12.

The above-described first mounting member 50 is formed of a metal plate with high strength, includes a horizontal base portion 51 at the bottom, and is provided with a wide U-shaped cutout 50a in the center. In addition, a protruding piece 52 protruding upward is provided in the center of the upper side of the base portion 51. Also, an insert hole 51a is formed below the protruding piece 52 in the base portion 51 and a foundation of a clip for fixing a harness (described below) is inserted into the insert hole 51a.

Double wing sections 53 located on both sides of the cutout 50a are formed to bulge forward, and a pair of extending sections 54 extending forward are formed at the upper end of the edge with the cutout 50a in the double wing sections 53. This extending section 54 protrudes into the space below an upper wall of the above-described upper frame 12 and functions to perform positioning by a portion contacting an inner surface of the upper wall of the upper frame 12. The upper end of the double wing section 53 is fixed to the upper rear face of the upper frame 12 by welding.

As mentioned above, the upper frame 12 of the present embodiment includes a complex shape with irregularities, so if a plate material with a thick thickness is used, it will be difficult to process, but because of the opening part 12a, if the plate thickness is thin, there is a risk of insufficient strength. However, since the metal first mounting member 50 is provided at the rear part of the upper frame 12, the upper frame 12 can be reinforced. Therefore, it is possible to avoid the possibility of insufficient strength of the upper part of the seatback frame. In other words, the first mounting member 50 also functions as a means of reinforcing the upper frame 12.

Furthermore, the pair of fixing insert holes 51b, through which screws or blind rivets or the like are inserted to fix the first mounting member 50 to the side frames 11A and 11B, are formed at both ends of the base portion 51 of the first mounting member 50.

On the rear face of the side frames 11A and 11B, as shown in FIG. 4, reinforcement panels 13A and 13B including fixing pieces 13a and 13b protruding toward the center side of the seatback are joined, and the components are fixed by fastening the base portion 51 of the above-described first mounting member 50 to the fixing pieces 13a and 13b with the pair of fixing insert holes 51b by screws or rivets. Instead of providing the fixing pieces 13a and 13b, protruding pieces protruding sideways may be provided on both sides of the base portion 51 and such protruding pieces may be fixed to the reinforcement panel or the side frame.

Furthermore, as shown in FIG. 4, a pair of monitor mounting brackets 14A and 14B, which are U-shaped in the rear view, are welded and fixed to the upper parts of both left and right double wing sections 53 of the above-described first mounting member 50, with the opening side facing downward. Bolt insert holes (not shown) for inserting bolts 15A and 15B for fixing the monitor are formed in horizontal piece portions on the upper side of the brackets 14A and 14B, and the bolts 15A and 15B fix the mounting portion of the rear part of the monitor case to the brackets 14A and 14B, thereby enabling the monitor to be mounted on the rear part of the seatback. Instead of fixing the brackets 14A and 14B to the first mounting member 50, a part of the first mounting member 50 may be deformed to form the bolt insert holes, etc., so that an electrical component mounting member (electrical component mounter) having the same function as the bracket may be provided directly on the first mounting member 50.

As shown in FIG. 3A and FIG. 3B, a pair of engagement holes 51c are provided near both sides of the above-mentioned insert hole 51a in the base portion 51 of the first mounting member 50 for coupling a second mounting member 60 (second mounter) described below to the first mounting member 50.

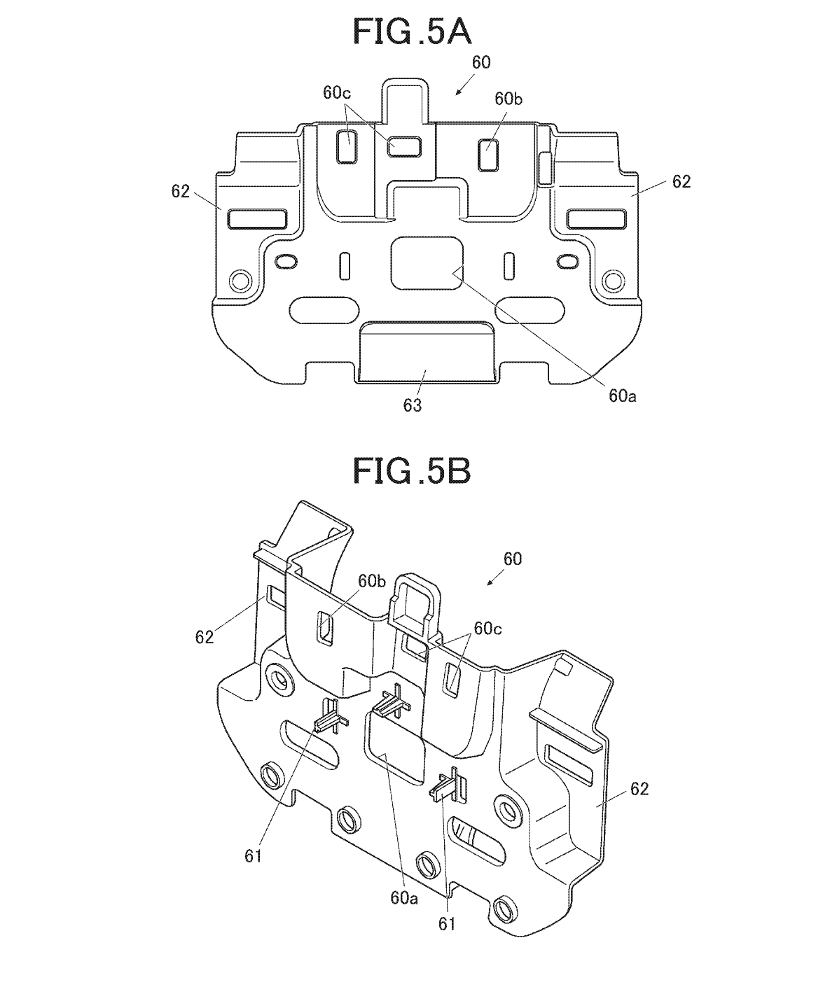

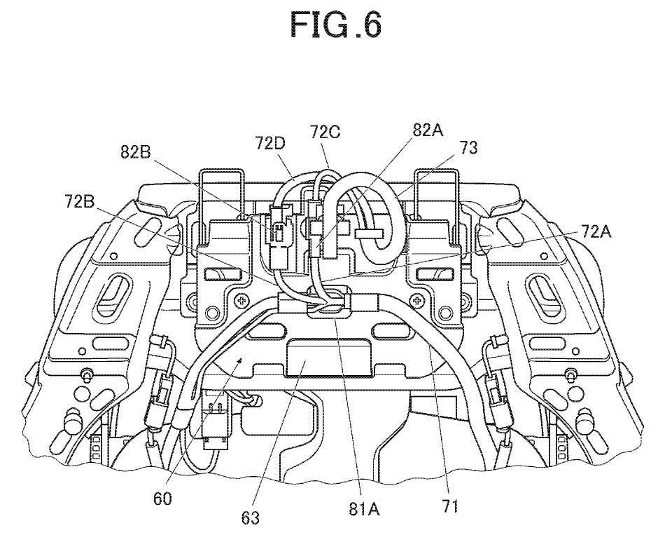

FIG. 5A and FIG. 5B show an example of a second mounting member 60 placed on the back of the above-described first mounting member 50, and FIG. 6 shows a state in which the second mounting member 60 is attached to the rear part of the first mounting member 50.

The above-described second mounting member 60 is formed of nonconductive synthetic resin in the shape of a plate, and is provided with an opening 60a in the center at a location corresponding to the insert hole 51a of the above-described first mounting member 50. One of the reasons that the second mounting member 60 is provided is to realize a harness organizing function that consolidates the plurality of harnesses and arranges them in an orderly fashion. Thus, the second mounting member 60 functions as a harness organizing plate. The second mounting member 60 functions to prevent electrical contact between the harnesses located in the rear part of the seatback and the metal first mounting member 50 for mounting the monitor.

As shown in FIG. 5B, a pair of latching protrusions 61 are formed in a position near both sides of the opening 60a on the surface of the second mounting member 60 facing the above first mounting member 50, and by inserting these latching protrusions 61 into the engagement holes 51c provided in the base portion 51 of the above-described first mounting member 50, the second mounting member 60 is attached to the rear face of the first mounting member 50 as shown in FIG. 6. In this state, the opening 60a (see FIG. 5B) provided in the second mounting member 60 matches the insert hole 51a (see FIG. 3B) of the harness fixing clip provided in the first mounting member 50, and the insert hole 51a is exposed in the opening 60a.

In addition, both sides of the second mounting member 60 are provided with a pair of overhanging wall sections 62 protruding backward to avoid interference with the harness. The area above the above-described opening 60a in the center and sandwiched between the above pair of overhanging wall sections 62 is a protruding surface portion protruding forward. The protruding surface portion is provided with an insert hole 60b into which the foundation of the clip for fixing the harness is inserted, and an insert hole 60c into which the mounting portion of a connector for connecting harnesses is inserted.

By providing the pair of overhanging wall sections 62 as described above, it is possible to protect the harness from interference with the edges of the brackets 14A and 14B as the electrical component mounting members and from being damaged. In other words, the pair of overhanging wall sections 62 serve as a protection section (protector) for the harness.

In addition, the protruding surface portion protruding forward is provided at the portion of the second mounting member 60 sandwiched by the pair of overhanging wall sections 62, and a second fixing section of the harness (insert holes 60b and 60c) is provided in this protruding surface portion. The above can contribute to compactness in the front-rear direction of the seat.

In the seatback according to the present embodiment, as shown in FIG. 6, the insert hole 51a exposed in the opening 60a of the second mounting member 60 is used to secure a harness bundle 71, which is a bundle of multiple harnesses, by inserting the harness bundle 71 into the insert hole 51a while gripping it with a clip 81A. Connectors 82A and 82B are provided to branch harnesses 72A and 72B branched from the harness bundle 71, and the branch harnesses 72A and 72B are secured by inserting the connectors 82A and 82B into the insert holes 60c. Furthermore, a harness bundle 73, which bundles the branch harnesses 72C and 72D connected to the other of the connectors 82A and 82B, is gripped by a clip 81B and inserted into the insert hole 60b to secure the harness bundle 73.

By providing the second mounting member 60 as described above to consolidate multiple harnesses in one place and fix them with the clip or the like, it is possible to orderly arrange multiple harnesses provided in the rear part of the seatback in which multiple harnesses are arranged in the rear part due to incorporating multiple electrical components, and also to avoid contact defects due to contact between the harnesses that may occur when the harnesses shake due to vehicle vibrations.

According to the above embodiment, the harness fixing sections (harness fixers) (60b, 60c) that fix the harness to the upper part frame are located toward the front than the rear end of the upper part frame 12 in the front-rear direction of the seat. Therefore, the harnesses 72A to 72D can be compactly arranged in a rear part space of the seatback.

Furthermore, since the first mounting member 50 and the second mounting member 60 are arranged on the rear part of the seatback frame 10, the first mounting member 50 is provided with a first fixing section (first fixer) (insert hole 51a) for the harness and the second mounting member 60 is provided with a second fixing section (second fixer) (insert holes 60b, 60c) for the harness, the multiple harnesses can be arranged in an orderly manner.

According to the above embodiment, the opening 60a is provided in the second mounting member 60 and the harness bundle 71 is fixed to the insert hole 51a provided in the base portion 51 of the first mounting member 50 on the inner side by the clip 81A. A similar insert hole may be provided in the second mounting member 60, and the harness bundle 71 may be fixed to the second mounting member 60 with a clip. However, since the second mounting member 60 is made of the synthetic resin while the first mounting member 50 is made of metal, the harness bundle 71 can be more firmly fixed by fixing to the first mounting member 50 as in the above embodiment.

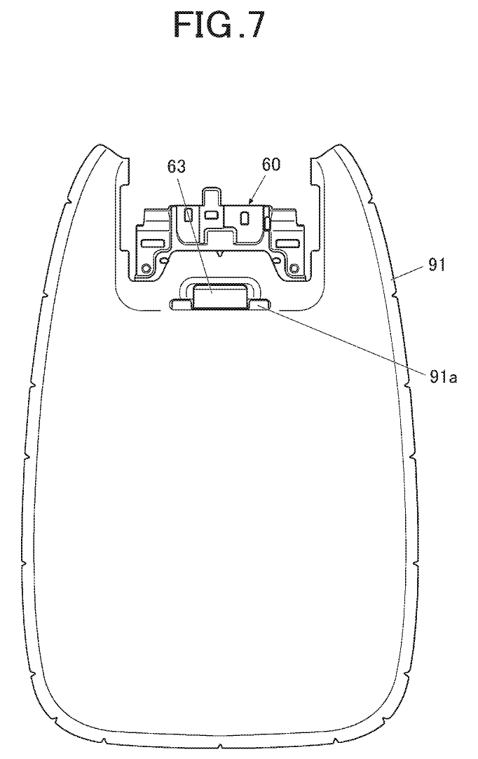

Furthermore, a hook 63 is provided in the center of the lower rear surface of the above second mounting member 60, and by engaging the hook 63 with a latching hole 91a provided on the end of a backboard 91 (see FIG. 7), and shaped to correspond to the hook 63, the upper end of the backboard 91 can be latched. The backboard 91 is a member mounted to cover the rear part of the seatback, and the lower edge is pre-fixed to the lower part of the seatback. After the harness has been provided in the rear part space of the seatback and fixed to the first mounting member 50, the upper edge is lifted up to cover the rear part of the seatback. The installation is completed by engaging the latching hole 91a with the hook 63.

The hook 63 for engaging the upper end of the backboard 91 could conceivably be provided at the lower part of the first mounting member 50, but it is more advantageous to provide it at the lower part of the second mounting member 60, because it is easier to engage the latching hole 91a of the backboard 91 to the hook.

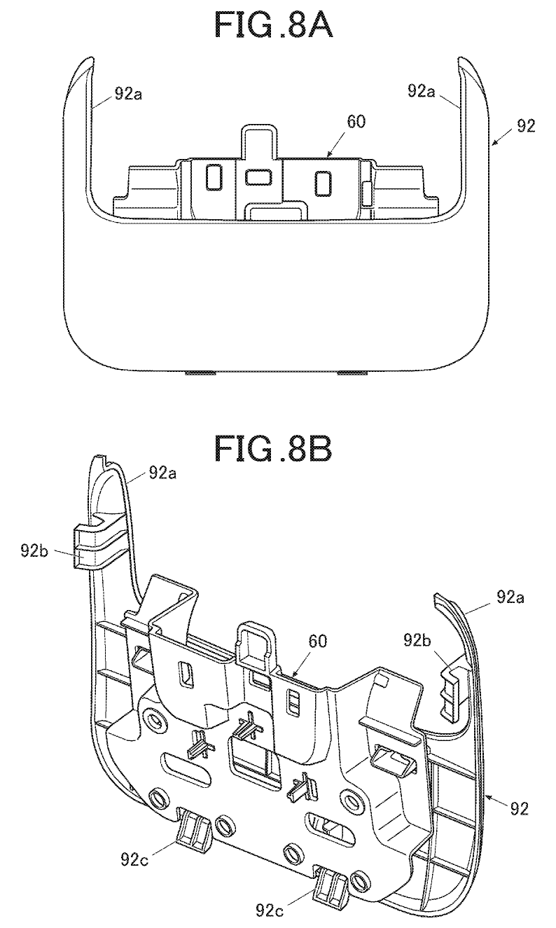

According to the present embodiment, as shown in FIG. 8A, a cover case 92 is mounted behind the above-described second mounting member 60 to cover the rear part of the second mounting member 60. The cover case 92 is arranged to cover at least the first fixing section (insert hole 51a) from the rear. This protects the fixing section of the harness from contact with foreign objects and makes it difficult for the harness to come off the seatback.

FIG. 8B shows details of the cover case 92. As shown in FIG. 8B, a pair of arm sections 92a extending upward are formed on both sides of the cover case 92, and an L-shaped latching piece 92b is provided at each tip of these arm sections 92a. Such latching pieces 92b are engaged with the inner side edge of the upper end of the side frames 11A and 11B. The lower edge of the cover case 92 is provided with a pair of latching claws 92c that protrude forward, and such latching claws 92c are latched to the lower edge of the second mounting member 60. This secures the cover case 92 to the rear part of the seatback.

### Modification Example

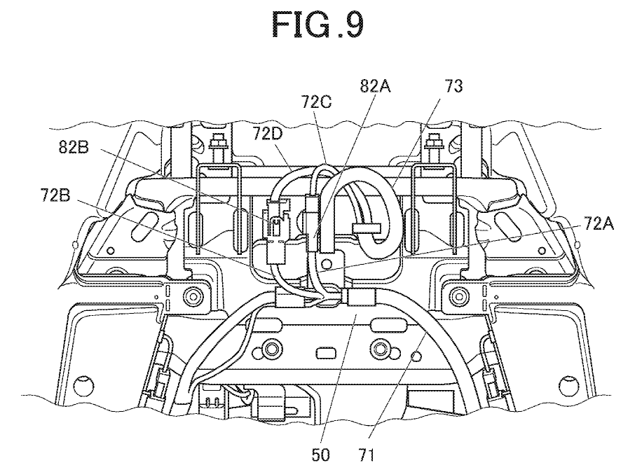

FIG. 9 shows a modification example of the above-described embodiment.

This modification example omits the second mounting member 60 which is for fixing the harness, and which is located at the rear part of the upper frame 12 in the above-described embodiment. The point where the foundation of the clip 81A, which grips the harness bundle 71, is inserted into the insert hole 51a provided in the center of the first mounting member 50 and secured is the same as in the above-described embodiment. Meanwhile, the connectors 82A and 82B, which are connected to branch harnesses 72A and 72B, are fixed to the insert holes provided in the upper frame 12, and the harness bundle 73 is fixed by the clip 81B to the latching piece provided on the upper part of the bracket 22 of the blower.

This configuration can reduce the number of components compared to the above-described embodiment while still having the function of fixing the harness in the predetermined position.

Although an embodiment of the present disclosure has been described above, the invention is not limited to the aforementioned embodiments and can be implemented with various changes without departing from the scope of the essentials of the embodiments. For example, the above embodiment describes a case in which the monitor and the blower are installed in the seatback as the electrical components, but it can be applied to a case in which the seatback is equipped with other electrical components other than the monitor and the blower such as a speaker, thereby achieving the same effect as the above embodiment.

In the above embodiment, the blower unit 20 is located on the upper frame 12, but it can be located in other positions, or it can be configured without the blower.

Furthermore, in the above embodiments, the seatback of the present disclosure is described as applied to a vehicle seat as an example. However, the present disclosure is not limited to vehicle seats, but can also be applied to seats for ships, aircrafts, and other vehicles.

A seatback includes: a seatback frame including a pair of side frames and an upper part frame that extends in a left-right direction and that is joined at both ends to an upper part of the pair of side frames; a harness that supplies power and a signal to an electrical component mounted on the seatback frame; and a harness fixer that fixes the harness to the upper part frame, wherein the harness fixer is located to the front than a rear end of the upper part frame in a front-rear direction of a seat.

According to the embodiment described above, the harness can be compactly arranged in the rear part space of the seatback because the harness fixing section, which fixes the harness to the upper part frame, is located to the front than the rear end of the upper part frame in the seat front-rear direction.

According to the seatback described above, the upper part frame includes a base and a protruding surface that protrudes forward than the base in the front-rear direction of the seat, and the harness fixer is located in a space formed by the protruding surface.

According to the embodiment described above, the harness can be more compactly arranged in the rear part space of the seatback.

The seatback described above, further includes: a first mounter that is fixed to the upper part frame from the rear of the seat; and a second mounter that is fixed to the first mounter from the rear of the seat, wherein the harness fixer includes, a first fixer that fixes the harness to the first mounter, and a second fixer that fixes the harness to the second mounter, and the second fixer is positioned to the front than the first fixer in the front-rear direction of the seat.

According to the embodiment described above, the first mounting member and the second mounting member are arranged in the rear part of the seatback frame, the first fixing section of the harness is provided on the first mounting member, and the second fixing section of a harness is provided on the second mounting member, so that the multiple harnesses can be arranged in an orderly manner.

According to the seatback described above, the first mounter, includes a first base that is joined to a rear face of the base of the upper part frame, and is formed in a shape that does not include an overlapping portion with the second fixer when viewed from the front of the seat.

According to the embodiment described above, the second fixing section can be located to the front than the rear end of the first mounting member, allowing the harness to be more compactly arranged in the rear part space of the seatback.

According to the seatback described above the first mounter is provided with a pair of electrical component mounters in which the electrical component is mounted to the seatback frame, and the second fixer is located between the pair of electrical component mounters in a seat width direction.

According to the embodiment described above, it is possible to contribute to making the mounting structure for attaching electrical components (monitor) to the seatback frame more compact in the seat width direction.

According to the seatback described above, the second mounter is formed including a pair of protectors extending along an outline of the pair of electrical component mounters, and the second fixer is provided between the pair of protectors in the seat width direction.

According to the embodiment described above, the harness can be protected from being damaged by interference with the edges of the electrical component mounting member (bracket).

The seatback described above, further including a cover that is fixed to the second mounter from the rear of the seat, wherein the cover is arranged to cover at least the first fixer from the rear.

According to the embodiment described above, the first fixing section that fixes the harness to the seatback can be protected by a cover member (cover), making it difficult for the harness to fall off the seatback.

According to the seatback described above, the second mounter further includes, a second base parallel to the first base of the first mounter, and a second protruding surface that protrudes forward in the front-rear direction of the seat than the second base, and the second fixer is located on the second protruding surface.

According to the embodiment described above, the second fixing section of the harness is positioned to the front than the second base portion, making it possible to contribute to compactness in the front-rear direction of the seat.

According to the seatback described above, the first mounter includes a third protruding surface protruding forward in the front-rear direction of the seat than the first base at a side in the seat width direction, and the third protruding surface is positioned to the rear than the second protruding surface.

According to the embodiment described above, the third protruding surface portion of the first mounting member is positioned to the rear than the second protruding surface portion of the second mounting member, making it possible to contribute to compactness in the front-rear direction of the seat.

According to the seatback described above the first mounter includes a welded portion that is welded to the upper part frame at an upper end of the first base, and the second mounter is positioned to avoid the welded portion.

According to the embodiment described above, it is possible to contribute to compactness in the front-rear direction of the seat.

Although some embodiments of the present disclosure have been described and illustrated in detail, the disclosed embodiments are made for purposes of not limitation but illustration and example only. The scope of the present disclosure should be interpreted by terms of the appended claims.

1. A seatback comprising:
a seatback frame including a pair of side frames and an upper part frame that extends in a left-right direction and that is joined at both ends to an upper part of the pair of side frames;
a harness that supplies power and a signal to an electrical component mounted on the seatback frame; and
a harness fixer that fixes the harness to the upper part frame,
wherein the harness fixer is located to the front than a rear end of the upper part frame in a front-rear direction of a seat.

2. The seatback according to claim 1, wherein,
the upper part frame includes a base and a protruding surface that protrudes forward than the base in the front-rear direction of the seat, and
the harness fixer is located in a space formed by the protruding surface.

3. The seatback according to claim 2, further comprising,
a first mounter that is fixed to the upper part frame from the rear of the seat; and
a second mounter that is fixed to the first mounter from the rear of the seat,
wherein,
the harness fixer includes,
a first fixer that fixes the harness to the first mounter, and
a second fixer that fixes the harness to the second mounter, and
the second fixer is positioned to the front than the first fixer in the front-rear direction of the seat.

4. The seatback according to claim 3, wherein,
the first mounter,
includes a first base that is joined to a rear face of the base of the upper part frame, and
is formed in a shape that does not include an overlapping portion with the second fixer when viewed from the front of the seat.

5. The seatback according to claim 4, wherein,
the first mounter is provided with a pair of electrical component mounters in which the electrical component is mounted to the seatback frame, and
the second fixer is located between the pair of electrical component mounters in a seat width direction.

6. The seatback according to claim 5, wherein,
the second mounter is formed including a pair of protectors extending along an outline of the pair of electrical component mounters, and
the second fixer is provided between the pair of protectors in the seat width direction.

7. The seatback according to claim 4, further comprising,
a cover that is fixed to the second mounter from the rear of the seat,
wherein the cover is arranged to cover at least the first fixer from the rear.

8. The seatback according to claim 7, wherein,
the second mounter further includes,
a second base parallel to the first base of the first mounter, and
a second protruding surface that protrudes forward in the front-rear direction of the seat than the second base, and
the second fixer is located on the second protruding surface.

9. The seatback according to claim 8, wherein,
the first mounter includes a third protruding surface protruding forward in the front-rear direction of the seat than the first base at a side in the seat width direction, and
the third protruding surface is positioned to the rear than the second protruding surface.

10. The seatback according to claim 9, wherein,
the first mounter includes a welded portion that is welded to the upper part frame at an upper end of the first base, and
the second mounter is positioned to avoid the welded portion.
